(19) United States
(12) Patent Application Publication
(10) Pub. No.: US 2023/0131363 A1
(43) Pub. Date: Apr. 27, 2023

(54) DRIVING ASSISTANCE DEVICE

(71) Applicant: KABUSHIKI KAISHA TOKAI RIKA DENKI SEISAKUSHO, Aichi (JP)

(72) Inventors: Naofumi KATO, Aichi (JP); Masanori KOSUGI, Aichi (JP); Hitoshi MURAKI, Aichi (JP); Tetsuya EGAWA, Aichi (JP)

(21) Appl. No.: 17/801,741

(22) PCT Filed: Feb. 26, 2021
(86) PCT No.: PCT/JP2021/007290

§ 371 Date: Aug. 23, 2022

(30) Foreign Application Priority Data
Mar. 3, 2020 (JP) 2020-035642

(51) Int. Cl. B60W 50/16; B60N 2/90

(52) U.S. Cl. CPC B60W 50/16; B60N 2/90; B60N 2002/981

(57) ABSTRACT

A driving assistance device includes a vibration-imparting unit to impart vibration to at least one of a seat and a seat belt on the side of a driver of a vehicle, and a control unit to, after the vehicle is transitioned to a movable state by start of driving assistance of the vehicle, notify the driver that it is ready to accept an operation by controlling the vibration-imparting unit to impart vibration to at least one of the seat and the seat belt.

### CROSS-REFERENCES TO RELATED APPLICATIONS

The present patent application claims the priority of Japanese patent application No. 2020/035642 filed on Mar. 3, 2020, and the entire contents of Japanese patent application No. 2020/035642 are hereby incorporated by reference.

### TECHNICAL FIELD

The present invention relates to a driving assistance device

### BACKGROUND ART

An information provision device is known Which provides information to a driver through sensation of soles of the driver (e.g., see Patent Literature 1),

The information provision device is operated so as to vibrate a footrest base for resting the foot of the driver sitting in the driver's seat of a vehicle to provide a state of an automated driving system to the driver. For example, the information provision device provides information from the automated driving system to the driver by imparting vibration with an intensity corresponding to the requirement level of driver engagement in automated driving, to the footrest base.

### CITATION LIST

### Patent Literature

Patent Literature 1: JP 2019/26213 A

### SUMMARY OF INVENTION

### Technical Problem

When the driver does not rest his foot on the footrest base, the information provision device disclosed in Patent Literature 1 will not allow the driver to feel vibration and recognize the provision of information.

It is an object of the invention to provide a driving assistance device which can allow the driver to recognize the information about driving assistance.

### Solution to Problem

According to an embodiment of the invention, a driving assistance device comprises:
a vibration-imparting unit to impart vibration to at least one of a seat and a seat belt on the side of a driver of a vehicle: and
a control unit to, after the vehicle is transitioned to a movable state by start of driving assistance of the vehicle, notify the driver that it is ready to accept an operation by controlling the vibration-imparting unit to impart vibration to at least one of the seat and the seat belt.

### Advantageous Effects of Invention

According to an embodiment of the invention, it is possible to provide a driving assistance device which can allow the driver to recognize the information about driving assistance,

### BRIEF DESCRIPTION OF DRAWINGS

FIG. 1A is an explanatory diagram illustrating the inside of a vehicle cabin in which a driving assistance device in an embodiment is arranged.

FIG. 1B is a block diagram illustrating the driving assistance device in the embodiment.

FIG. 2A is an explanatory diagram illustrating a driver viewed from a side.

FIG. 2B is a block diagram illustrating a vehicle control system including the driving assistance device in the embodiment.

FIG. 3A is an explanatory diagram illustrating a drive signal for a vibration pattern of the driving assistance device in the embodiment.

FIG. 3B is an explanatory diagram illustrating a drive signal for a vibration pattern of the driving assistance device in the embodiment.

FIG. 3C is an explanatory diagram illustrating a drive signal for a vibration pattern of the driving assistance device in the embodiment.

FIG. 3D is an explanatory diagram illustrating a drive signal for a vibration pattern of the driving assistance device in the embodiment.

FIG. 4 is a flowchart showing an operation of the driving assistance device in the embodiment.

### DESCRIPTION OF EMBODIMENTS

(Summary of the Embodiments)

A driving assistance device in an embodiment includes a vibration-imparting unit to impart vibration to at least one of a seat and a seat belt on the side of a driver of a vehicle, and a control unit to, after the vehicle is transitioned to a movable state by start of driving assistance of the vehicle, notify the driver that it is ready to accept an operation by controlling the vibration-imparting unit to impart vibration to at least one of the seat and the seat belt.

The driver, when getting in the vehicle, sits in the seat on the drive's side and fastens the seat belt. That is, the seat and the seat belt are always in close contact with the driver. The driving assistance device can provide information about driving assistance by vibrating the seat or the seat belt that is in close contact with the driver.

### Embodiment

(General Configuration of a Driving Assistance Device 1)

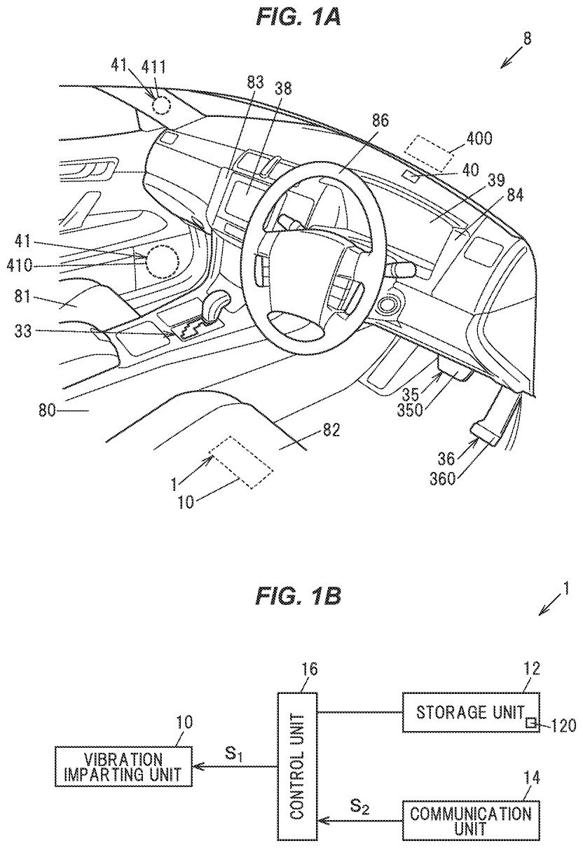

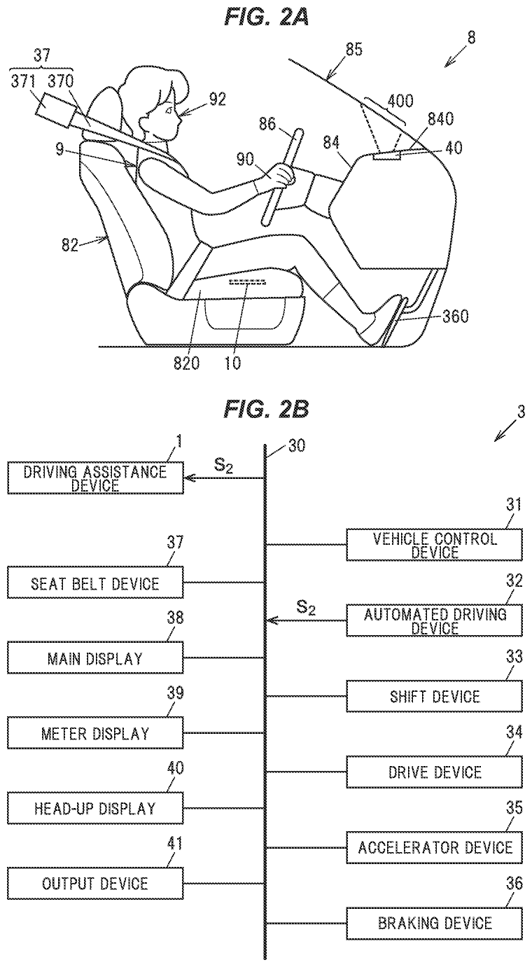

FIG. 1A is an explanatory diagram illustrating the inside of a vehicle cabin, and FIG. 1B is a block diagram illustrating the driving assistance device. FIG. 2A is an explanatory diagram illustrating a driver viewed from a side, and FIG. 2B is a block diagram illustrating a vehicle control system. In each drawing of the embodiment described below, a scale ratio may be different from an actual ratio. In addition, in FIGS. 1B and 2B, flows of main signals and information are indicated by arrows.

The driving assistance device 1 is configured to notify that the vehicle is transitioned to a movable state when driving assistance by an automated driving function of a vehicle 8 is performed.

In particular, as shown in FIGS. 1A, 1B and 2A, the driving assistance device 1 has a vibration-imparting unit 10 to impart vibration to at least one of a D seat 82 as the seat and a seat belt 370 on a driver's side of a vehicle 8, and a control unit 16 that notifies a driver that it is ready to accept an operation by controlling the vibration-imparting unit 10 to impart vibration to at least one of the D seat 82 and the seat belt 370 after the vehicle 8 is transitioned to a movable state by start of driving assistance of the vehicle 8.

The control unit 16 of the driving assistance device 1 is also configured to cause vibration to be imparted to at least one of the D seat 82 and the seat belt 370 until the driver starts an operation.

The movable state is a state in which a shift device 33 of the vehicle 8 is shifted to a drive range (=D range) enabling forward movement or a reverse range (=R range) enabling backward movement.

The driving assistance device 1 is included in a vehicle control system 3 of the vehicle 8. as shown in FIG. 2B. The vehicle control system 3 includes the driving assistance device 1, a vehicle control device 31, an automated driving device 32, the shift device 33, a drive device 34, an accelerator device 35, a braking device 36, a seat belt device 37, a main display 38, a meter display 39, a head-up display 40, and an output device 41. In the vehicle control system 3. the driving assistance device 1 and other devices, etc., are interconnected through an in-vehicle LAN (Local Area Network) 30.

(Configuration of the Driving Assistance Device 1)

As shown in FIG. 1B, the driving assistance device 1 includes the vibration-imparting unit 10, a storage unit 12, a communication unit 14, and the control unit 16.

The vibration-imparting unit 10 in the present embodiment is configured to impart vibration to the D seat 82, in case that vibration is imparted to the seat belt 370, the driving assistance device 1 is configured such that a retractor 371 of the seat belt device 37 serves as the vibration-imparting unit 10. Meanwhile, in case that vibration is imparted to the D seat 82 and the seat belt 370, the driving assistance device I is configured such that an electronic device to generate vibration, which is arranged in the D seat 82, and the retractor 371 serve as the vibration-imparting unit 10.

As shown in FIG. 1A, the vibration-imparting unit 10 is arranged in a cushion portion 820 of the D seat 82. The vibration-imparting unit 10 includes, e.g., a voice coil motor or an eccentric motor, etc. The vibration-imparting unit 10 in the present embodiment includes a voice coil motor, as an example.

The vibration-imparting unit 10 imparts vibration to the D seat 82 in response to a drive signal Si output from the control unit 16, as shown in FIG, TB. Vibration is continuously imparted until the driver starts driving, as an example.

As an example, start of drive by the driver is determined by the automated driving device 32 and may be a combination of plural detections among detection of occupancy of the D seat 82, detection of fastening of the seat belt 370, detection of grip on a steering wheel 86, detection of operation on an accelerator pedal 350 and detection of depression of a brake pedal 360, or may be detection of a specified driver's driving position. The automated driving device 32 in the present embodiment determines start of drive when the conditions of detection of occupancy of the D seat 82 by a driver 9, detection of fastening of the seat belt 370, detection of grip on the steering wheel 86, and detection of depression of the brake pedal 360 are satisfied, as shown in FIG. 2A.

The detection of driving position is performed, e.g., by processing an image from a camera arranged in the vehicle cabin. The automated driving device 32 determines that the driver is in the specified driving position by the fact that, e.g., a face 92 of the driver 9 is facing forward, hands 90 of the driver 9 are gripping the steering wheel 86, and the brake pedal 360 is being depressed, etc., as shown in FIG. 2A. The grip on the steering wheel 86 may be detected by processing an image from a camera or may be detected by a sensor arranged on the steering wheel 86. An operation on the brake pedal 360 is detected by the braking device 36.

The storage unit 12 is, e.g., a storage device such as a semiconductor memory, an HDD (=Hard Disk Drive), or an SSD (=Solid State Drive). The storage unit 12 in the present embodiment is a semiconductor memory, as an example. The storage unit 12 stores vibration pattern information 120 which is information of vibration patterns. The vibration pattern information 120 includes patterns of vibration to be presented to the driver which are patterns corresponding to contents of the driving assistance to be presented.

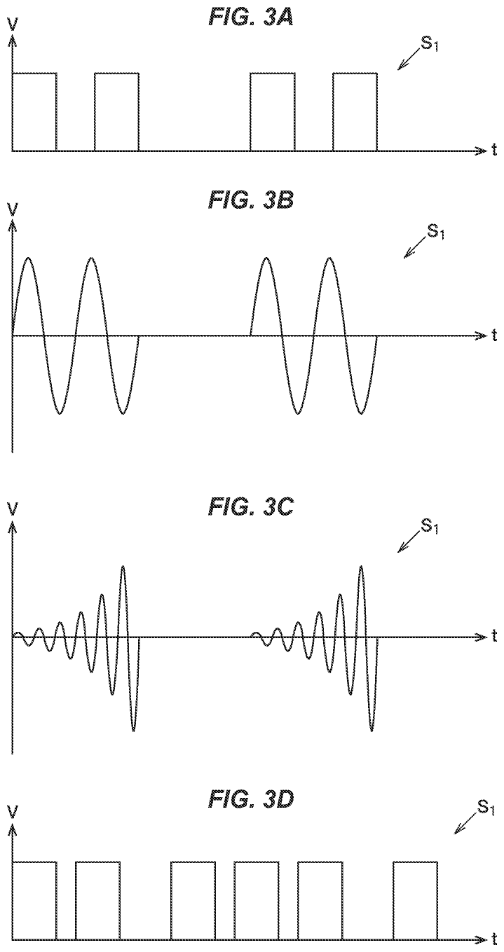

FIGS. 3A to 3D are diagrams illustrating drive signals for respective vibration patterns. In FIGS. 3A to 3D, the vertical axis indicates voltage V, and the horizontal axis indicates time t. The vibration patterns described below are examples and the drive signals Si can be considered to have various waveforms.

FIG. 3A shows the pulsed drive signals S₁. This drive signals S₁ is an example of a vibration pattern to notify of the movable state. In this this vibration pattern, two consecutive pulses are presented, and after an interval, two consecutive pulses are presented again, as an example. This vibration pattern is continued until start of drive.

FIG. 3B shows the sine wave drive signal S₁. This drive signals S₁ is an example of a vibration pattern to notify of the movable state. In this this vibration pattern, two cycles of a sine wave are presented, and after an interval, two cycles of a sine wave are presented again. This vibration pattern is continued until start of drive.

FIG. 3C shows the gradually increasing sine wave drive signal S₁. This drive signals S₁ is an example of a vibration pattern to notify of the movable state. This this vibration pattern is a pattern mimicking forced vibration, and is continued at intervals until start of drive. As a modification, the drive signal Si may be a pattern mimicking damped vibration or may be a vibration pattern in which the forced vibration and the damped vibration are connected.

FIG. 3D shows the pulsed drive signals S₁. This drive signals S₁ is an example of a vibration pattern to give a notification when drive is not started for a predetermined period of time after transition to the movable state. In this vibration pattern, two consecutive pulses are presented and three pulses are then presented. This vibration pattern is continued until start of drive.

The communication unit 14 is configured to be capable of communicating with the vehicle control device 31, etc., through the in-vehicle LAN 30.

The control unit 16 is, e.g., a microcomputer composed of a CPU (=Central Processing Unit) performing calculation and processing, etc., of acquired data according to a stored program, and a RAM (=Random Access Memory) and a ROM (=Read Only Memory) as semiconductor memories, etc. The ROM stores, e.g., a program for operation of the control unit 16. The RAM is used as, e.g., a storage area to temporarily store calculation results. etc. The control unit 16 also has, inside thereof, a means to generate a clock signal and operates based on the clock signal.

The control unit 16 outputs the drive signal S₁ according to the vibration pattern information 120 stored in the storage unit 12, to the vibration-imparting unit 10 based on notification instruction signal S₂ obtained through the communication unit 14. The notification instruction signal S₂ is output from, e.g., the automated driving device 32.

(Configuration of the In-Vehicle LAN 30)

The in-vehicle LAN 30 enables reciprocal exchange of signals and information, etc., between electronic devices connected using communications standard such as CAN (Controller Area Network) or LIN (Local Interconnect Network).

(Configuration of the Vehicle Control Device 31)

The vehicle control device 31 comprehensively controls electronic devices mounted on the vehicle 8. The vehicle control device 31 has basic functions of the vehicle 8, e.g., an authentication function to authenticate an electronic key or a portable terminal, a function of unlocking doors after successful authentication, a function of controlling the drive device 34 according to an operation performed on the accelerator device 35, and a function of controlling the main display 38, the meter display 39 and the head-up display 40, etc.

(Configuration of the Automated Driving Device 32)

The automated driving device 32 controls automated driving functions of the vehicle 8. The automated driving functions include, e.g., a function of automated driving to a destination, a function of suppressing lane departure, a function of driving while keeping a distance to a preceding vehicle, a function of avoiding collision with surrounding obstacles, and a function of maintaining a set speed, etc.

The automated driving device 32 has a function of automatically shifting a transmission range of the shift device 33 to the D range or the R range to assist the driving of the driver after predetermined conditions based on driver's schedule for the day or frequent activities, or a parking spot of the vehicle 8, etc., are satisfied. These predetermined conditions are, e.g., when the parking spot is where the vehicle has been parked in the past, and when a destination predicted based on the schedule is a frequent destination, etc.

The driver's schedule for the day is, e.g., a schedule that is input to a mobile terminal of the driver and is shared with the automated driving device 32 through communication between the automated driving device 32 and the mobile terminal. Meanwhile, the frequent activities are calculated from history of operations performed on the vehicle 8, which is history based on the time and parking spots and recorded by the automated driving device 32.

The parking position is to store a location of the parked vehicle 8, with the GPS (=Global Positioning System) mounted on the vehicle 8 and a sensor to monitor the surroundings of the vehicle 8.

When the driver gets in the vehicle 8 and the predetermined conditions according to the schedule, frequency and parking spot, etc., described above are satisfied, the automated driving device 32 shifts the transmission range of the shift device 33 from the P range to the D range or the R range so as to be ready to drive. At this time, the automated driving device 32 may, e.g., show an image to notify of the movable state on at least one of the main display 38, the meter display 39 and the head-up display 40.

(Configuration of the Shift Device 33)

As shown in FIG. IA, the shift device 33 is arranged on a floor console 80 located between a P seat 81 and the D seat 82. The shift device 33 includes a transmission of the vehicle 8 and is configured to change a combination of gears of the transmission. The vehicle 8 in the present embodiment is an AT (=Automatic Transmission) vehicle. Therefore, the shift device 33 mainly includes P range (=parking range), N range (=neutral range), D range (=drive range), and R range (=reverse range).

The P range is an operating position which is selected when parking the vehicle 8 and at which the gears in the transmission mesh together to prevent the vehicle 8 from moving. The N range is an operating position at which the gears in the transmission do not mesh and the vehicle 8 is displaceable. The D range is an operating position at which the vehicle 8 moves forward. The R range is an operating position at which the vehicle 8 moves rearward.

The shift device 33 in the present embodiment is configured to automatically shift to each range under the control of the automated driving device 32.

(Configuration of the Drive Device 34)

The drive device 34 is composed of an internal combustion engine (=gasoline engine, diesel engine), or a motor, or an internal combustion engine and a motor. The drive device 34 is connected to a propeller shaft through the transmission, and wheels of the vehicle 8 on at least one of the front side and the rear side are rotationally driven by rotation of the propeller shaft.

(Configuration of the Accelerator Device 35)

The accelerator device 35 includes the accelerator pedal 350 shown in FIG. 1A. The accelerator device 35 detects the depression amount of the accelerator pedal 350 and outputs information of the depression amount to the vehicle control device 31 or the automated driving device 32 through the in-vehicle LAN 30.

(Configuration of the Braking Device 36)

The braking device 36 includes the brake pedal 360 shown in FIG. 1A. The braking device 36 applies a braking force to at least one of a hydraulic brake and a drum brake provided on each wheel, according to the depression amount of the brake pedal 360.

(Configuration of the Seat Belt Device 37)

As shown in FIG. 2A, the seat belt device 37 includes the belt-shaped seat belt 370 to restrain the body of the driver 9 in the D seat 82, and the retractor 371 to wind out and wind up the seat belt 370.

The retractor 371 can wind out and wind up the seat belt 370 by using a motor.

(Configuration of the Main Display 38)

As shown in FIG. 1A, the main display 38 is arranged on a center console 83 located diagonally in front of an occupant sitting in the P seat 81 and the driver sitting in the D seat 82. The main display 38 is a liquid crystal display or an organic EL (=Electro-Luminescence) display.

(Configuration of the Meter Display 39)

The meter display 39 is arranged on the instrument panel 84 in front of the driver. A speedometer of the vehicle 8, and a rev counter indicating revolution speed of an internal combustion engine or a fuel gauge, etc., in case that the drive device 34 is an internal combustion engine, are displayed as images on the meter display 39. A plurality of such displays are prepared and switched according to the grade of the vehicle 8 or the driving mode, etc.

(Configuration of the Head-Up Display 40)

The head-up display 40 is arranged on an upper surface 840 of the instrument panel 84 to project an image onto a projection area 400 of a windshield 85. The projected image is, e.g., an image related to current speed or route guidance. The image related to route guidance is, e.g., an image of an arrow indicating a right or left turn or display of distance to a place to make a right or left turn. Alternatively, the head-up display 40 may be configured to have a display unit and to display an image on the display unit.

(Configuration of the Output Device 41)

As shown in FIG. 1A, the output device 41 includes plural speakers 410 and 411 arranged on doors and pillars. Music and voice as well as warning sound, etc., are output from the speakers 410 and 411. As a modification, the driving assistance device 1 may provide notification by sound in addition to vibration. In addition, notification may be provided by display on the display device such as the main display 38, the meter display 39 and the head-up display 40 or by lighting of an indicating lamp.

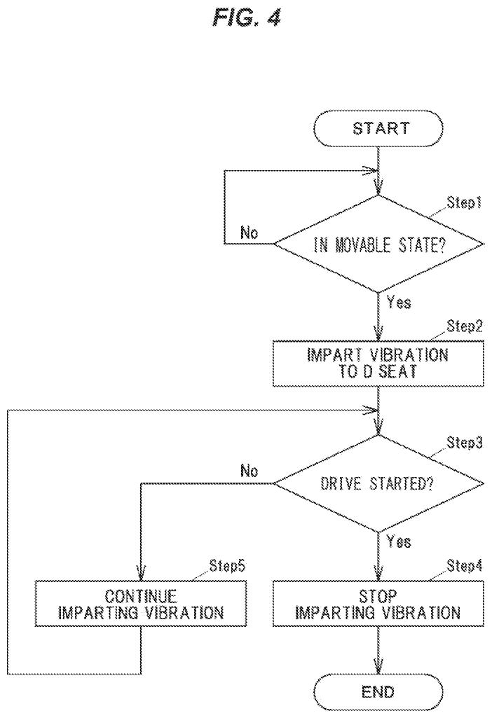

Next, an operation of the driving assistance device 1 in the present embodiment will be described in reference to the flowchart of FIG. 4. A case where the automated driving device 32 automatically controls the shift device 33 to shift to the D range or the R. range after the driver sits in the D seat 82 will be described here.

(Operation)

When it is “Yes” in Step 1, i.e., when the notification instruction signal S₂ is input through the communication unit 14, the control unit 16 of the driving assistance device 1 determines that the vehicle 8 is in the movable state (Step 1: Yes).

Next, based on the vibration pattern information 120 stored in the storage unit 12, the control unit 16 generates and outputs the drive signal S₁ to the vibration-imparting unit 10 and thereby imparts vibration to the D seat 82 to notify the driver that the vehicle is ready to drive (Step 2).

Next, the control unit 16 monitors whether drive is started. When drive is started (Step 3: Yes), the control unit 16 stops output of the drive signal S₁ to stop imparting vibration (Step 4) and ends the operation. Start of drive is determined based on the notification instruction signal S₂ output from the automated driving device 32.

Here, when drive is not started in Step 3 (Step 3: No), the control unit 16 continuously imparts vibration (Step 5) and proceeds the process to Step 3. In this regard, when drive is not started for a certain period of time, the control unit 16 may change the vibration pattern.

(Effects of the Embodiment)

The driving assistance device 1 in present embodiment can provide information about driving assistance to a driver. Since this driving assistance device 1 can impart vibration to at least one of the D seat 82 and the seat belt 370 which are in close contact with the driver's body, it is possible to provide information about driving assistance to the driver as compared to when vibration is applied to a member that is not necessarily in close contact with the body.

Since the driving assistance device 1 imparts vibration from when the vehicle is transitioned to the movable state to when drive is started, it is possible to suppress an operation performed without noticing that the vehicle 8 is in the movable state, as compared to when such a configuration is not adopted.

Since the driving assistance device 1 notifies of the movable state by sound in addition to vibration, it is easy for the driver to recognize that the vehicle is in the movable state, as compared to when notifying by only one of them.

Although some embodiment and modifications of the invention have been described, these embodiment and modifications are merely examples and the invention according to claims is not to be limited thereto. These new embodiment and modifications thereof may be implemented in various other forms, and various omissions, substitutions and changes, etc., can be made without departing from the gist of the invention. In addition, not all combinations of the features described in these embodiment and modifications are necessary to solve the problem of the invention. Further, these embodiment and modifications thereof are included within the scope and gist of the invention and also within the invention described in the claims and the range of equivalency.

### REFERENCE SIGNS LIST

1 DRIVING ASSISTANCE DEVICE

3 VEHICLE CONTROL SYSTEM

8 VEHICLE

9 DRIVER

10 VIBRATION-IMPARTING UNIT

33 SHIFT DEVICE

37 SEAT BELT DEVICE

41 OUTPUT DEVICE

82 D SEAT

370 SEAT BELL

1. A driving assistance device, comprising:
a vibration-imparting unit to impart vibration to at least one of a seat and a seat belt on the side of a driver of a vehicle; and
a control unit to, after the vehicle is transitioned to a movable state by start of driving assistance of the vehicle, notify the driver that it is ready to accept an operation by controlling the vibration-imparting unit to impart vibration to at least one of the seat and the seat belt.

2. The driving assistance device according to claim 1, wherein the control unit causes vibration to be imparted to at least one of the seat and the seat belt until the driver starts the operation.

3. The driving assistance device according to claim 1, wherein the control unit outputs a pulsed drive signal with a vibration pattern of presenting two consecutive pulses, and after an interval, presenting two consecutive pulses again, to the vibration-imparting unit.

4. The driving assistance device according to claim 1, wherein the control unit outputs a sine wave drive signal with a vibration pattern of presenting two cycles of a sine wave, and after an interval, presenting two cycles of a sine wave again, to the vibration-imparting unit.

5. The driving assistance device according to claim 1, wherein the control unit outputs a sine wave drive signal with a vibration pattern of presenting gradually increasing sine waves at intervals, to the vibration-imparting unit.

6. The driving assistance device according to claim 1, wherein the vibration-imparting unit comprises an electronic device to generate vibration that is arranged in a cushion portion of the seat.

7. The driving assistance device according to claim 6, wherein the electronic device to generate vibration is configured to comprise a voice coil motor or an eccentric motor.

8. The driving assistance device according to claim 1, wherein the vibration-imparting unit comprises a retractor of a seat belt device.

9. The driving assistance device according to claim 1, wherein the control unit notifies, after the transition to the movable state, the driver that it is ready to accept the operation by outputting sound from an output device.

10. The driving assistance device according to claim 1, wherein the movable state comprises a state in which a shift device of the vehicle is shifted to a drive range enabling forward movement or a reverse range enabling backward movement.
